(19) United States
(12) Patent Application Publication
(10) Pub. No.: US 2026/0186608 A1
(43) Pub. Date: Jul. 2, 2026

(54) TOUCHSCREEN AND DISPLAY DEVICE INCLUDING THE SAME

(71) Applicant: LG Display Co., Ltd., Seoul (KR)

(72) Inventors: Yang Sik LEE, Paju-si (KR); Ook Sang YOO, Paju-si (KR)

(73) Assignee: LG Display Co., Ltd., Seoul (KR)

(21) Appl. No.: 19/383,223

(22) Filed: Nov. 7, 2025

(30) Foreign Application Priority Data
Dec. 30, 2024 (KR) 10-2024-0200966

(51) Int. Cl. G06F 3/044; G06F 3/041

(52) U.S. Cl. CPC G06F 3/0445; G06F 3/0412; G06F 2203/04111

(57) ABSTRACT

A display device can include a display panel configured to display an image, and a touchscreen disposed on the display panel, the touchscreen including a first touch routing line layer, an insulating layer covering the first touch routing line layer, a second touch routing line layer disposed on the insulating layer, and a plurality of touch routing lines including a contact hole configured to interconnect the first touch routing line layer and the second touch routing line layer. Also, the plurality of touch routing lines include at least two interlayer structure change sections where interlayer wiring positions of the first touch routing line layer and the second routing line layer are changed.

### CROSS-REFERENCE TO RELATED APPLICATIONS

This application claims priority to Korean Patent Application No. 10-2024-0200966, filed in the Republic of Korea on Dec. 30, 2024, the entirety of which is hereby incorporated by reference into the present application as if fully set forth herein.

### BACKGROUND

### Field of the Disclosure

The present disclosure relates to a touchscreen and a display device including the same.

### Discussion of the Related Art

In accordance with advances in information technology, the market for display devices, which are connection media between users and information, is expanding. Accordingly, the use of display devices such as light emitting display (LED) devices, quantum dot display (QDD) devices, liquid crystal display (LCD) devices, etc. is increasing.

The above-mentioned display devices include a display panel including sub-pixels, a driver configured to output a drive signal for driving of the display panel, a power supply configured to generate power to be supplied to the display panel or the driver, etc.

In such display devices, when a drive signal, for example, a scan signal, a data signal, or the like, is supplied to sub-pixels formed at the display panel, selected ones of the sub-pixels transmit light therethrough or directly emit light and, as such, an image can be displayed.

However, existing display devices include routing lines that can exhibit significant resistance deviations between the lines, e.g., due to the use of different conductive materials or different routing lengths. This resistance imbalance can cause signal delays and inter-channel noise, which may degrade touch sensitivity and the overall user experience. Also, as the number of lines increases and displays become larger, this type of imbalance can become particularly pronounced. Further, prior approaches to routing line architecture present challenges to achieving a narrow bezel area.

Thus, a need exists for a display device having an improved configuration that can provide more uniform resistance for wiring lines, reduce noise and improve touch sensing sensitivity, and provide for a smaller bezel area.

### SUMMARY OF THE DISCLOSURE

Accordingly, the present disclosure is directed to a touchscreen and a display device including the same that substantially obviate one or more problems due to limitations and disadvantages of the related art.

The present disclosure aims to enhance the performance of a touchscreen (e.g., reduction or minimization of noise between touch channels, touch sensing sensitivity enhancement, etc.) through a reduction in resistance deviation between wirings (resistance compensation) or minimization thereof, and to enable achieve a narrow bezel when a display device including a touchscreen is embodied.

In one aspect of the present disclosure, a display device includes a display panel configured to display an image, and a touchscreen disposed on the display panel, the touchscreen including a first touch routing line layer, an insulating layer covering the first touch routing line layer, a second touch routing line layer disposed on the insulating layer, and a plurality of touch routing lines including a contact hole configured to interconnect the first touch routing line layer and the second touch routing line layer, in which the plurality of touch routing lines includes at least two interlayer structure change sections where interlayer wiring positions of the first touch routing line layer and the second routing line layer are changed.

The plurality of touch routing lines can include at least one of a first area including one first touch routing line layer disposed as a lower layer, or a second area including one second touch routing line layer disposed as an upper layer.

The first area and the second area can be alternately disposed for at least one wiring.

The plurality of touch routing lines can include a third area including the first area and the second area.

Numbers of contact holes respectively included in two neighboring touch routing lines in the plurality of touch routing lines can be different.

Wiring resistances of the two neighboring touch routing lines can be similar or equal.

Numbers of contact holes respectively included in two neighboring touch routing lines in the plurality of touch routing lines can be similar or equal.

Wiring lengths of the two neighboring touch routing lines can be similar or equal.

The plurality of touch routing lines can include a line extension portion extending from the contact hole in one direction.

The plurality of touch routing lines can include at least one of a first area including one first touch routing line layer disposed as a lower layer or a second area including one second touch routing line layer disposed as an upper layer. The first area and the second area can be alternately disposed for at least one wiring.

The line extension portion can be included in a third area including the first area and the second area and can extend to the first area or the second area.

In another aspect of the present disclosure, a touchscreen includes a first touch routing line layer, an insulating layer covering the first touch routing line layer, a second touch routing line layer disposed on the insulating layer, and a plurality of touch routing lines including a contact hole configured to interconnect the first touch routing line layer and the second touch routing line layer, in which the plurality of touch routing lines includes at least two interlayer structure change sections where interlayer wiring positions of the first touch routing line layer and the second routing line layer are changed.

Numbers of contact holes respectively included in two neighboring touch routing lines in the plurality of touch routing lines can be different.

Wiring resistances of the two neighboring touch routing lines can be similar or equal.

Numbers of contact holes respectively included in two neighboring touch routing lines in the plurality of touch routing lines can be equal.

Wiring lengths of the two neighboring touch routing lines can be similar or equal.

### BRIEF DESCRIPTION OF THE DRAWINGS

The accompanying drawings, which are included to provide a further understanding of the disclosure and are incorporated in and constitute a part of this application, illustrate embodiment(s) of the disclosure and along with the description serve to explain the principle of the disclosure. In the drawings:

FIG. 1 is a block diagram schematically showing a light emitting display device according to an embodiment of the present disclosure;

FIG. 2 is an illustrative view showing a smartphone embodied based on the light emitting display device according to an embodiment of the present disclosure;

FIG. 3 is an illustrative view showing a portion of the smartphone of FIG. 2 corresponding to a touchscreen according to an embodiment of the present disclosure;

FIG. 4 is a cross-sectional view showing a touch routing line connected to a touch electrode in FIG. 3 according to an embodiment of the present disclosure;

FIG. 5 is a view showing a layout and a cross-section of a touch routing line according to an embodiment of the present disclosure;

FIG. 6 is a view showing a layout of a touch routing line according to another embodiment of the present disclosure;

FIG. 7 is a view showing a cross-section of a touch routing line in the form of a layout according to another embodiment of the present disclosure;

FIG. 8 is a view showing the cross-section of the touch routing line of FIG. 7 according to an embodiment of the present disclosure;

FIG. 9 is a view showing the cross-section of the touch routing line of FIG. 7 according to an embodiment of the present disclosure; and

FIG. 10 is a diagram explaining the wiring structure according to an embodiment of the present disclosure, as compared to the wiring structure of a related experimental example.

### DETAILED DESCRIPTION OF THE EMBODIMENTS

The display device according to the present disclosure can be embodied as a television, an image player, a personal computer (PC), a home theater, a car electric device, a smartphone, etc., without being limited thereto. The display device according to the present disclosure can be embodied as a light emitting display (LED) device, a quantum dot display (QDD) device, etc. For convenience of description, however, the following description will be given in conjunction with an example in which the display device according to the present disclosure is a light emitting display device configured to directly emit light based on an inorganic light emitting diode or an organic light emitting diode.

The features of various embodiments of the present disclosure can be partially or entirely coupled to or combined with each other and can be interlocked and operated in technically various ways, and the embodiments can be carried out independently of or in association with each other. Also, the term “can” used herein includes all meanings and definitions of the term “may”.

Reference will now be made in detail to embodiments of the present disclosure, examples of which may be illustrated in the accompanying drawings. In the following description, when a detailed description of well-known functions or configurations related to this document is determined to unnecessarily obscure a gist of the inventive concept, the detailed description thereof will be omitted or may be briefly provided. The progression of processing steps and/or operations described is an example; however, the sequence of steps and/or operations is not limited to that set forth herein and may be changed as is known in the art, with the exception of steps and/or operations necessarily occurring in a particular order. Like reference numerals designate like elements throughout. Names of the respective elements used in the following explanations may be selected only for convenience of writing the specification and may be thus different from those used in actual products.

The aforementioned objectives, features, and advantages of the present disclosure will be described in detail with reference to the accompanying drawings, enabling those skilled in the art to easily implement the technical idea of the disclosure. Detailed descriptions of well-known technologies related to the disclosure will be omitted or may be briefly provided, if they unnecessarily obscure its essence. Hereinafter, embodiments of the present disclosure will be described in detail with reference to the accompanying drawings. Identical reference numerals in the drawings are used to refer to identical or similar components.

Although terms such as ‘first,’ ‘second,’ and the like are used to describe various components, these components are not limited by these terms. These terms are merely used to distinguish one component from another, and unless explicitly stated otherwise, the first component may be the second component, and vice versa.

Throughout the specification, unless explicitly stated otherwise, each component may be singular or plural. Throughout the drawings and the detailed description, unless otherwise described, the same drawing reference numerals should be understood to refer to the same elements, features, and structures. The relative size and depiction of these elements may be exaggerated for clarity, illustration, and convenience.

The singular expressions used in this specification include the plural expression unless the context clearly indicates otherwise. In this application, terms such as ‘comprising’ or ‘including’ should not be interpreted as necessarily including all the components or steps listed in the specification; some components or steps may be excluded, or additional components or steps may be included.

Throughout the specification, the term ‘A and/or B’ means A, B, or both A and B, unless otherwise stated, and the term ‘C to D’ means C or more and D or less, unless otherwise stated.

Any implementation described herein as an “example” is not necessarily to be construed as preferred or advantageous over other implementations.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

In the description of the various embodiments of the present disclosure, where positional relationships are described, for example, when a position relation between two parts is described as, for example, “on,” “over,” “under,” and “next,” or the like, one or more other parts may be located between the two parts unless a more limiting term, such as “just” or “direct(ly)” is used. For example, where an element or layer is disposed “on” another element or layer, a third element or layer may be interposed therebetween.

In describing a temporal relationship, when the temporal order is described as, for example, “after,” “subsequent,” “next,” and “before,” a case that is not continuous may be included unless a more limiting term, such as “just,” “immediate(ly),” or “direct(ly)” is used.

Also, when an element or layer is “connected,” “coupled,” or “adhered” to another element or layer denotes that the element or layer can not only be directly connected or adhered to the other element or layer, but also be indirectly connected or adhered to the other element or layer with one or more intervening elements or layers “disposed,” or “interposed” between the elements or layers, unless otherwise specified. It should be understood to mean that elements may be so disposed to directly contact each other, or may be so disposed without directly contacting each other.

When describing quantitative or numerical relationships, terms such as “equal” and “the same” generally denote “substantially equal” and “substantially the same”, or “similar or equal” and “similar or the same”. That is, on the basis of that two elements being equal or the same, a certain error range is permitted, such as one percent, five percent, ten percent, etc.

It will be apparent to those skilled in the art that various modifications and variations can be made to the embodiments of the present disclosure without departing from the technical idea or scope of the present disclosure. Thus, it is intended that the present disclosure covers the modifications and variations of this disclosure provided they come within the scope of the appended claims and their equivalents.

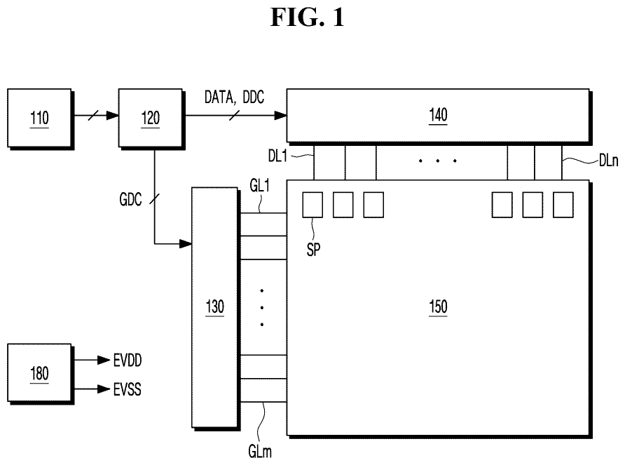

FIG. 1 is a block diagram schematically showing a light emitting display device according to an embodiment of the present disclosure.

As shown in FIG. 1, the light emitting display device can include a timing controller 120, a gate driver (e.g., a gate driving circuit) 130, a data driver (e.g., a data driving circuit) 140, a display panel 150, a power supply 180, etc.

An image supplier (e.g., a set or a host system) 110 can output various drive signals as well as an image data signal supplied from an exterior thereof or an image data signal (e.g., a data signal) stored in an internal memory. The image supplier 110 can supply the data signal and the various drive signals to the timing controller 120.

The timing controller 120 can output a gate timing control signal GDC for control of operation timing of the gate driver 130, a data timing control signal DDC for control of operation timing of the data driver 140, various synchronization signals, etc. The timing controller 120 can supply, to the data driver 140, a data signal DATA supplied from the image supplier 110, together with the data timing control signal DDC. The timing controller 120 can take the form of an integrated circuit (IC) and, as such, can be mounted on a printed circuit board, without being limited thereto.

The gate driver 130 can output a gate signal (or a gate voltage) in response to the gate timing control signal GDC, etc. supplied from the timing controller 120. The gate driver 130 can supply a scan signal to sub-pixels included in the display panel 150 via gate lines GL1 to GLm. The gate driver 130 can include a shift register, a level shifter, etc. The level shifter can output clock signals, a start signal, etc. based on signals and voltages output from the timing controller 120 and the power supply 180. The shift register can operate based on the clock signals, the start signal, etc. and can output gate signals through the gate lines GL1 to GLm. The gate driver 130 can take the form of an IC or can be directly formed on the display panel 150 in the form of a gate-in-panel structure, without being limited thereto.

The data driver 140 can sample and latch the data signal DATA in response to the data timing control signal DDC, etc. supplied from the timing controller 120, can convert a data signal having a digital form into a data voltage having an analog form, and can then output the resultant data voltage. The data driver 140 can supply the data voltage to the sub-pixels included in the display panel 150 via data lines DL1 to DLn. The data driver 140 can take the form of an IC and, as such, can be mounted on the display panel 150 or a printed circuit board, without being limited thereto.

The power supply 180 can generate a high-level voltage and a low-level voltage based on an external input voltage supplied from an exterior thereof, can output the high-level voltage and the low-level voltage through a high-level power line EVDD and a low-level power line EVSS, respectively. The power supply 180 can generate and output not only the high-level voltage and the low-level voltage, but also a voltage required for driving of the gate driver 130 (for example, a gate-high voltage and a gate-low voltage), a voltage required for driving of the data driver 140, etc.

The display panel 150 can display an image, corresponding to a drive signal including the gate signal and the data voltage, a drive voltage including the high-level voltage and the low-level voltage, etc. The sub-pixels of the display panel 150 can directly emit light. The display panel 150 can be manufactured based on a substrate having stiffness or ductility, such as glass, silicon, polyimide, or the like. According to an embodiment, the display panel 150 can be a flexible display or include a flexible substrate. The sub-pixels, which emit light, can include red, green, and blue subpixels or red, green, blue, and white subpixels.

For example, one sub-pixel SP can be connected to a first data line DL1, a first gate line GL1, the high-level power line EVDD, and the low-level power line EVSS and can include a pixel circuit that includes a switching transistor, a driving transistor, a capacitor, an organic light emitting diode, etc. The sub-pixel SP used in the light emitting display device directly emits light and, as such, the circuit configuration thereof is complex. In addition, a compensation circuit configured to compensate for degradation of not only the organic light emitting diode configured to emit light, but also the driving transistor configured to supply drive current required for driving of the organic light emitting diode, etc. is also diverse. Accordingly, it is noted that, in FIG. 1, the sub-pixel SP is simply shown in the form of a block.

Meanwhile, heretofore, the timing controller 120, the scan driver 130, the data driver 140, etc. have been described as individual configurations, respectively. However, one or more of the timing controller 120, the scan driver 130, and the data driver 140 can be integrated together in one IC in accordance with an implementation method of the light emitting display device.

Hereinafter, an embodiment of the present disclosure will be described in conjunction with an example in which the above-described light emitting display device is embodied as a smartphone.

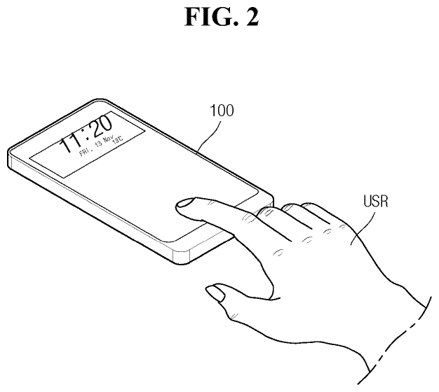

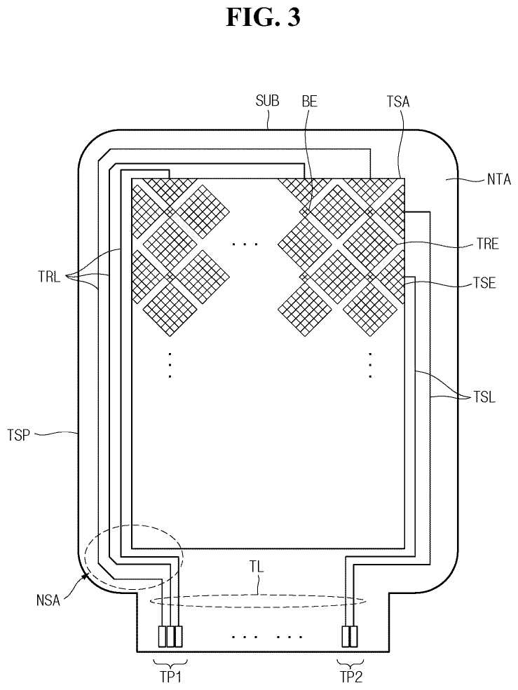

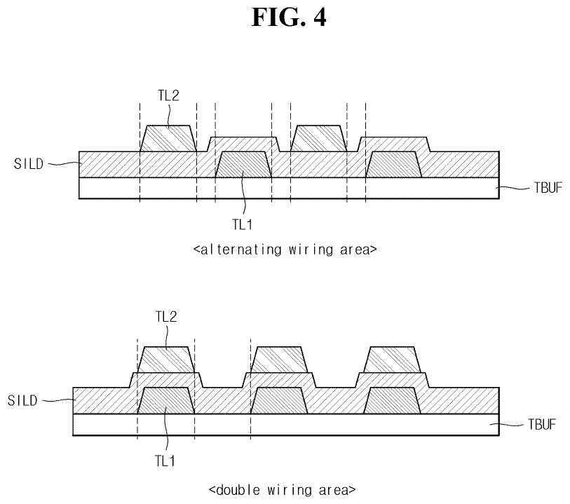

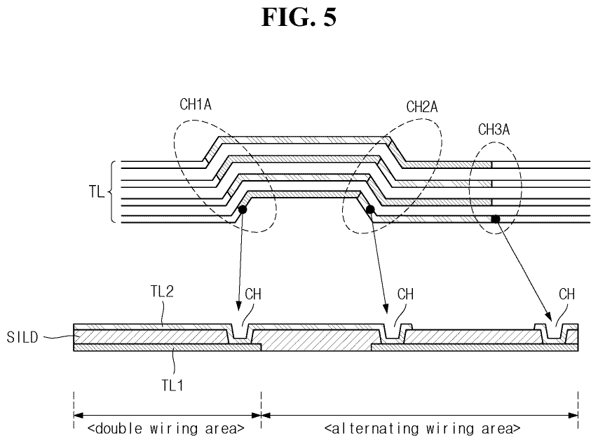

FIG. 2 is an illustrative view showing a smartphone embodied based on the light emitting display device according to an embodiment of the present disclosure. FIG. 3 is an illustrative view showing a portion of the smartphone of FIG. 2 corresponding to a touchscreen according to an embodiment of the present disclosure. FIG. 4 is a cross-sectional view showing a touch routing line connected to a touch electrode in FIG. 3 according to an embodiment of the present disclosure. FIG. 5 is a view showing a layout and a cross-section of the touch routing line according to a first embodiment of the present disclosure.

As shown in FIGS. 2 and 3, the light emitting display device can be embodied as a smartphone 100. The smartphone 100 can include a touchscreen TSP configured to receive an input from a finger of a user USR, a stylus, or the like.

The touchscreen TSP can include a substrate (or a film) SUB, a touch sensing electrode TSE, a touch driving electrode TRE, a bridge electrode BE, a touch driving line TRL, a touch sensing line TSL, a touch routing line TL, a touch pad TP1-TP2, etc. For example, the touchscreen TSP can be a thin, transparent layer or panel (e.g., an invisible or transparent grid of sensors) that is disposed on top of the display panel, in which the touchscreen TSP is configured to detect a touch position. According to an embodiment, the touchscreen TSP together with the display panel 150 can be collectively referred to as a touchscreen display (e.g., an on-cell type of configuration). According to another embodiment, the touch sensors and touch routing lines can be integrated within the display panel such as being embedded with the subpixels (e.g., an in-cell type of configuration).

The touch sensing electrode TSE, the touch driving electrode TRE, and the bridge electrode BE can each be disposed in plural in a touch sensing area TSA defined on the substrate SUB. The touch driving line TRL, the touch sensing line TSL, the touch routing line TL, and the touch pad TP1-TP2 can each also be disposed in plural in a touch non-sensing area NTA defined on the substrate SUB. In one embodiment, the substrate SUB can be understood as one surface of a display panel 150. For example, the touch sensing electrode TSE, the touch driving electrode TRE, and the bridge electrode BE can be disposed on an encapsulation layer of the display panel 150.

The touch sensing electrode TSE and the touch driving electrode TRE can each have a rectangular, rhomboid, or diamond shape, but embodiments are not limited thereto. Although the touch sensing electrode TSE and the touch driving electrode TRE are illustrated as being patterned in a mesh form to enhance transmittance (light transmission) characteristics by way of example, the present disclosure is not limited thereto.

The touch sensing electrode TSE and the touch driving electrode TRE are disposed in the touch sensing area TSA defined on the substrate SUB, and can be disposed on different layers, respectively, to be insulated from each other by an insulation layer interposed therebetween. The bridge electrode BE can be disposed at an intersection between the touch sensing electrode TSE and the touch driving electrode TRE to provide electrical connection between physically-separated touch sensing electrodes TSE and electrical connection between physically-separated touch driving electrodes TRE on the touch sensing area TSA.

The touch driving line TRL can be connected to the touch driving electrode TRE. The touch driving line TRL can transmit a touch drive voltage applied through a first touch pad TP1 to the touch driving electrode TRE. The touch sensing line TSL can be connected to the touch sensing electrode TSE. The touch sensing line TSL can acquire touch sensing information formed at the touch sensing electrode TSE and can transmit the acquired information to a second touch pad TP2.

The touch routing line TL includes wirings configured to connect the touch driving electrode TRE and the touch sensing electrode TSE to the first touch pad TP1 and the second touch pad TP2, and can include the touch driving line TRL and the touch sensing line TSL. In other words, the touch driving line TRL and the touch sensing line TSL are lines disposed in the touch non-sensing area NTA and can be collectively referred to as the touch routing line TL.

As shown in FIGS. 3 and 4, the touch routing line TL can include a first touch routing line layer TL1 and a second touch routing line layer TL2, which are disposed on a touch buffer layer TBUF formed on the substrate SUB under the condition that an insulation layer SILD is interposed therebetween. For example, the first touch routing line layer TL1 can be disposed on the touch buffer layer TBUF, whereas the second touch routing line layer TL2 can be disposed on the insulation layer SILD which covers the first touch routing line layer TL1.

The touch routing line TL can include an alternating wiring area where two touch routing line layers are alternately disposed to have an alternating interlayer relationship as an upper layer and a lower layer for each wiring, and a double wiring area where two touch routing line layers are disposed together or over top of each other for each wiring. To achieve this configuration, the first touch routing line layer TL1 and the second touch routing line layer TL2 can be disposed not to overlap with each other in the alternating wiring area, and the first touch routing line layer TL1 and the second touch routing line layer TL2 can be disposed to overlap with each other in the double wiring area.

When the wiring of the touch routing line TL is configured to include the alternating wiring area and the double wiring area, it can be possible to overcome the constraints of the device with a limited design area or small space constraints (a layout design area) and to achieve a narrow bezel.

As shown in FIG. 5, the touch routing line TL, which includes the first touch routing line layer TL1 and the second touch routing line layer TL2, is disposed under the condition that the insulation layer SILD is interposed between the first touch routing line layer TL1 and the second touch routing line layer TL2. However, the first touch routing line layer TL1 and the second touch routing line layer TL2 can be electrically connected to each other through a contact hole CH exposing a structure disposed therebeneath. For example, a plurality of contact holes CH can be used to electrically connect the first touch routing line layer TL1 and the second touch routing line layer TL2 at multiple locations.

In accordance with the first embodiment, the touch routing line TL disposed in the alternating wiring area can include at least two interlayer structure change sections where interlayer wiring positions of the first touch routing line layer TL1 and the second touch routing line layer TL2 are changed. Here, the at least two interlayer structure change sections can be continuous to one another in a plane or cross-section of the touch routing line TL.

For example, in a first section defined between a first contact hole area CH1A and a second contact hole area CH2A, the second touch routing line layer TL2 can be disposed. However, in a second section defined between the second contact hole area CH2A and a third contact hole area CH3A, the first touch routing line layer TL1 can be disposed in accordance with a change in wiring position. That is, the touch routing line TL can have at least two sections where a vertical wiring position is changed such that each layer forming a single layer in the alternating wiring area is changed from an upper layer to a lower layer or from a lower layer to an upper layer (hereinafter referred to as interlayer structure change sections). For example, to help ensure uniform electrical properties, the touch routing line include can include at least two interlayer structure change sections, in which the positioning of the wirings are interchanged. For example, the wiring can have multiple transitions, such as transitioning from a double wiring configuration, to one area where the wiring is positioned at an upper layer (e.g., above SILD), while in another area the wiring can be positioned at a lower layer (e.g., below SILD). For example, touch routing line layer TL1 and the second touch routing line layer TL2 can include different materials. This strategic swapping of layers and materials can help equalize the resistance along the touch routing line.

By disposing the touch routing line layer with the interlayer structure change sections in the alternating wiring area, it can be possible to modify process conditions (or design conditions) so that, even if there is a difference in sheet resistance between the first touch routing line layer TL1 and the second touch routing line layer TL2, the first touch routing line layer TL1 and the second touch routing line layer TL2 have the same resistance (or the same distance). Accordingly, it can be possible to reduce or minimize resistance deviation between wirings. In other words, swapping the positions of the different wiring layers at certain points can make their overall electrical resistance the same or substantially equal, which can reduce inconsistencies between the wirings.

Additionally, in accordance with the first embodiment, in order to reduce or minimize the resistance deviation between the wirings, positions of contact holes CH included in the touch routing line TL can be varied based on at least one of an arrangement structure condition or an arrangement area condition. Positions of the contact holes CH can differ in the first contact hole area CH1A and the second contact hole area CH2A, whereas positions of the contact holes CH are the same in the third contact hole area CH3A. In this situation, when resistances of wirings of the touch routing line TL are equal or similar, positions of the contact holes CH can differ, but the number of the contact holes CH can be constant. Here, the condition that the resistances of the wirings of the touch routing line TL are equal or similar can mean that total lengths of the wirings of the touch routing line TL disposed between a first point (a starting point) connected to the touch pad TP1-TP2 and a second point (an ending point) connected to the touch sensing electrode TSE or the touch driving electrode TRE included in the touch sensing area TSA are equal or similar.

For example, the first contact hole area CH1A can be included in contact area that facilitates electrical connection between the first touch routing line layer TL1 and the second touch routing line layer TL2 included in non-linear contacts in the double wiring area (e.g., points assisting in connection between upper and lower layers in areas where wirings are bent or a curved section of wiring). The second contact hole area CH2A can be included in contact area that facilitates electrical connection between the first touch routing line layer TL1 and the second touch routing line layer TL2 included in non-linear contacts in the alternating wiring area. The third contact hole area CH3A can be included in a contact area that facilitates electrical connection between the first touch routing line layer TL1 and the second touch routing line layer TL2 included in a linear contact (e.g., a straight section of wiring) in the alternating wiring area (e.g., a point assisting in connection between upper and lower layers in an area where wirings are linearly disposed without being bent). For example, the contact hole areas can be the connection points that electrically link the top and bottom layers of wiring together. These connection points can be strategically placed in different locations. For example, some connection points are located in non-linear areas where the wiring bends or curves, while others are located in linear areas where the wiring runs in a straight line.

Meanwhile, the structure of the touch routing line TL described in FIG. 5 can reduce or minimize resistance deviations between the wirings of a non-linear section NSA of FIG. 3 (e.g., a section including both linear and non-linear portions, but including a greater number of non-linear portions) when the wirings are routed. Furthermore, it can be possible to enhance the performance of the touchscreen (e.g., to reduce or to minimize noise between touch channels, to enhance touch sensing sensitivity, etc.) through reduction or minimization of the resistance deviation between the wirings.

In addition, FIG. 5 explains an example of a method for reducing or minimizing resistance deviation between the wirings of the touch routing line TL when the resistances of the wirings are equal or similar. Therefore, when the resistances of the wirings of the touch routing line TL differ, at least one of the condition associated with positions of the contact holes CH or the condition associated with the number of the contact holes CH can be varied in order to compensate for the resistance deviation.

In addition, in the present disclosure, for convenience of description, the structure of the touch routing line has been described as an example. However, this structure can also be applied to a signal line or a voltage line, which includes long wirings on the display panel and, as such, can exhibit resistance deviation between the wirings, such as a data line configured to transmit data voltage, a gate line configured to transmit a gate voltage, or the like.

Hereinafter, other embodiments will be described, which can be based on the first embodiment. That is, the embodiments described below can include an interlayer structure change section within an alternating wiring area. However, to mainly describe parts that have been changed or added, as compared to the first embodiment, the description of the interlayer structure change section will be omitted in the following description.

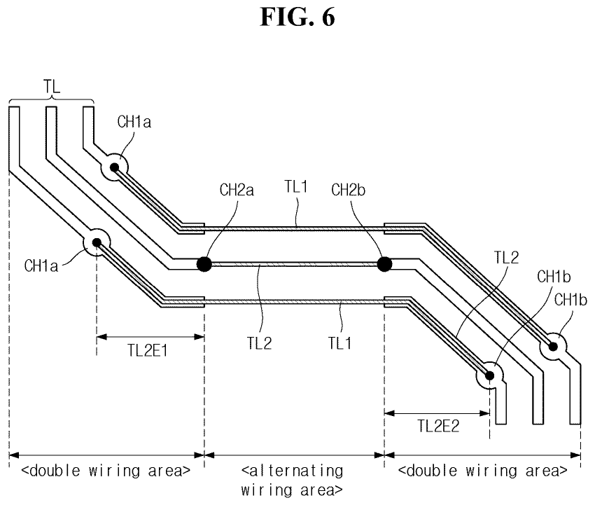

FIG. 6 is a view showing a layout of the touch routing line according to a second embodiment.

Meanwhile, it should be noted that FIG. 6 not only shows the touch routing line on a plane, but also shows some sections to aid in understanding wiring structures of the first touch routing line layer TL1 and the second touch routing line layer TL2, which are disposed on different layers.

As shown in FIG. 6, in accordance with the second embodiment, the touch routing line TL can include line extension portions TL2E1 and TL2E2 each extending in one direction from a corresponding one of first contact holes CH1a and CH1b to reduce or minimize resistance deviation between wirings. In other words, the line extension portions TL2E1 and TL2E2 can be made shorter or longer, which can help selectively adjust the resistance of different wirings so that the different wirings can all have substantially the same resistance, even in a curved area (e.g., such as a rounded corned area of the bezel, etc.).

The line extension portions TL2E1 and TL2E2 can be included in double wiring areas, respectively. The line extension portions TL2E1 and TL2E2 can extend from the first contact holes CH1a and CH1b disposed in the double wiring areas of the touch routing line TL, respectively, under the condition that an alternating wiring area is interposed between the double wiring areas. When viewed from the top plan, the line extension portions TL2E1 and TL2E2 can be alternately disposed not to overlap with line extension portions of a neighboring touch routing line. For example, the line extension portions can be staggered so they do not overlap with (e.g., not placed immediately adjacent to) a line extension portion of an adjacent wiring line.

For example, the 1-1-th line extension portion TL2E 1 can be disposed to extend from the 1-1-th contact hole CH1a of the touch routing line TL included in one double wiring area toward the alternating wiring area. Meanwhile, the 1-2-th line extension portion TL2E2 can be disposed to extend from the 1-2-th contact hole CH1b of the touch routing line TL included in the other double wiring area toward the alternating wiring area.

The 1-1-th line extension portion TL2E1 and the 1-2-th line extension portion TL2E2 can extend to have the same length or different lengths in accordance with positions of the 1-1-th contact hole CH1a and the 1-2-th contact hole CH1b, in order to reduce or minimize resistance deviation between wirings.

In accordance with the second embodiment, the alternating wiring area and each double wiring area include the first touch routing line layer TL1 and the second touch routing line layer TL2, but the thickness of the second touch routing line layer TL2 can be greater than the thickness of the first touch routing line layer TL1 (or vice versa).

For example, the second touch routing line layer TL2, which has a greater thickness than the first touch routing line layer TL1, can be included in the alternating wiring area. Since the second touch routing line layer TL2 is disposed above the first touch routing line layer TL1, there can be an advantage in that the second touch routing line layer TL2 can be formed to have a greater thickness than the first touch routing line layer TL1, taking into consideration occurrence of resistance deviation.

Additionally, when there is a difference in sheet resistance due to the thickness difference between the first touch routing line layer TL1 and the second touch routing line layer TL2, at least one of the first contact hole CH1a or CH1b or the second contact hole CH2a or CH2b can be varied in position to reduce or minimize the resistance deviation between wirings.

Meanwhile, in FIG. 6, an example in which the line extension portions TL2E1 and TL2E2 are disposed only at the touch routing line TL including the first contact holes CH1a and CH1b has been shown and described. Additionally, in FIG. 6, an example is illustrated in which the first contact holes CH1a and CH1b including the line extension portions TL2E1 and TL2E2 are disposed only at inclined portions (diagonal portions) of the touch routing line TL, respectively. However, this is merely one example, and can be varied in accordance with the positions, structures, shapes, etc. of the wirings. This will be referenced in a third embodiment described below.

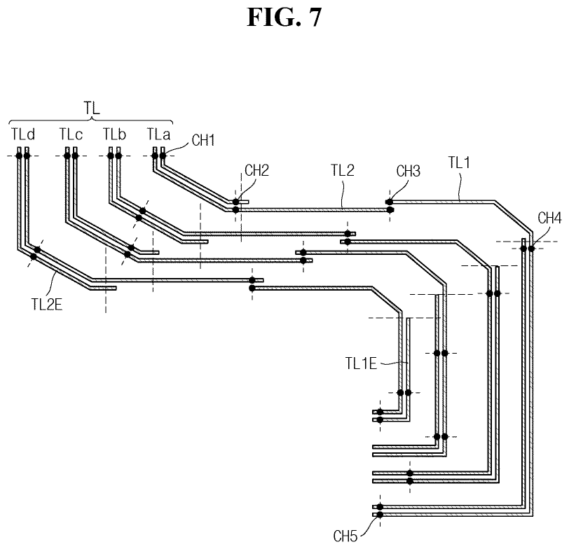

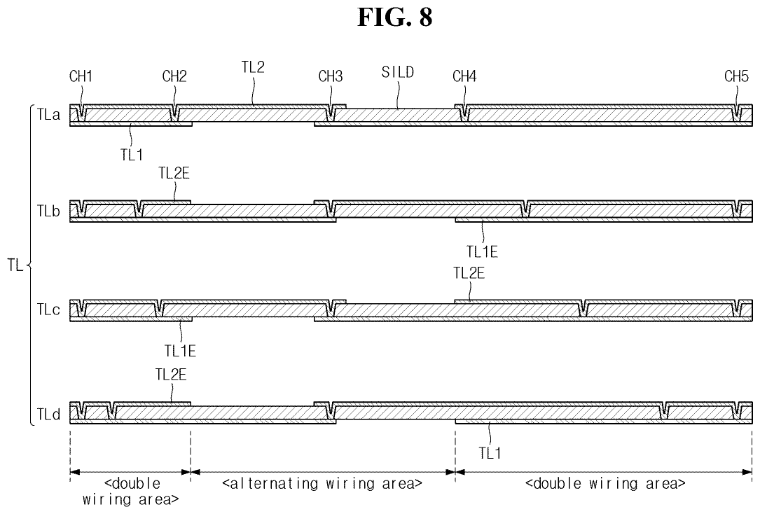

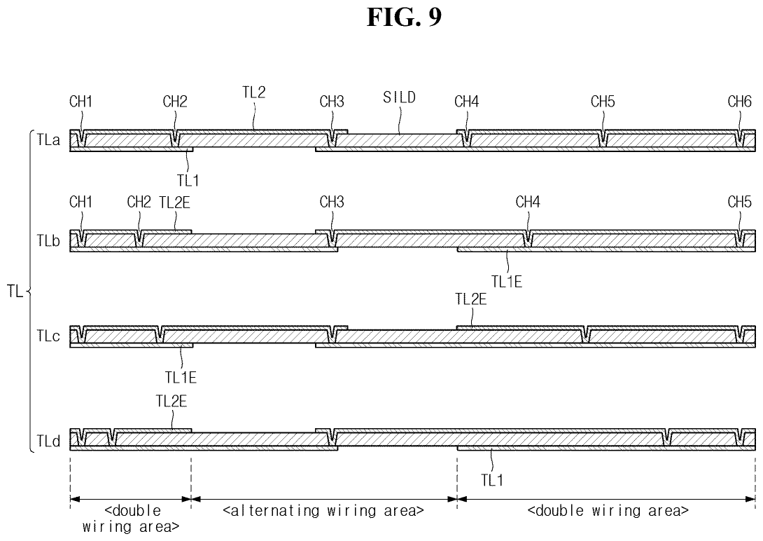

FIG. 7 is a view showing a cross-section of the touch routing line in the form of a layout configuration in accordance with the third embodiment. FIG. 8 is a view showing the cross-section of the touch routing line of FIG. 7 in accordance with the third embodiment. FIG. 9 is a view showing the cross-section of the touch routing line of FIG. 7 in accordance with a variation of the third embodiment.

Meanwhile, it should be noted that FIG. 7 shows the touch routing line in cross-section while excluding an insulating layer to aid in understanding the wiring structure and the contact structure of the first touch routing line layer TL1 and the second touch routing line layer TL2, which are disposed on different layers.

As shown in FIGS. 7 and 8, in accordance with the third embodiment, the touch routing line TL can include line extension portions TL1E and TL2E to reduce or minimize resistance deviation between wirings. The line extension portions TL1E and TL2E can extend from contact holes included in the touch routing line TL, respectively, as described in the second embodiment. For example, each of the line extension portions can also be referred to as an overhang portion, that overhangs from a corresponding contact hole and extends for a certain distance. Furthermore, the line extension portions TL1E and TL2E can extend toward an alternating wiring area while being included in double wiring areas, respectively, as described in the second embodiment.

In accordance with the third embodiment, the line extension portions TL1E and TL2E can also be included in neighboring touch routing lines TL, such as a 1-2-th touch routing line TLb, a 1-3-th touch routing line TLc, and 1-4-th touch routing line TLd, excluding a 1-1-th touch routing line TLa.

Additionally, in accordance with the third embodiment, the line extension portions TL1E and TL2E can be included not only in the first touch routing line layer TL1, but also in the second touch routing line layer TL2, as a first-layer line extension TL1E and a second-layer line extension TL2E.

Additionally, in accordance with the third embodiment, when wiring resistances of the touch routing lines TL are equal or similar, positions of contact holes can differ, as in first to fifth contact holes CH1 to CH5, but numbers of the contact holes in the touch routing lines TL can be equal. In this situation, the same numbers of contact holes can be included in the same wiring areas, respectively, as apparent from first and second contact holes CH1 and CH2 included in one double wiring area and fourth and fifth contact holes CH4 and CH5 included in the other double wiring area.

On the other hand, in accordance with the variation of the third embodiment of FIG. 9, when wiring resistances of the touch routing lines TL differ, the number of contact holes in one touch routing line, for example, first to sixth contact holes CH1 to CH6 of the 1-1-th touch routing line TLa, can be different from those of the remaining touch routing lines TLb to TLd, to compensate for resistance deviation.

For example, the 1-1-th touch routing line TLa can have a greater number of contact holes, by at least one, than the remaining touch routing lines TLb to TLd to compensate for resistance deviation. Conversely, the 1-1-th touch routing line TLa can also have a smaller number of contact holes, by at least one, than the remaining touch routing lines TLb to TLd to compensate for resistance deviation. That is, the number of contact holes can be determined based on the relationship between the touch routing line that can cause resistance deviation and the surrounding touch routing lines.

The third embodiment and the variation thereof can enable wirings to be formed without being disconnected by virtue of the line extension portions TL1E and TLE2 when positions of the wirings through contact holes are varied, and can design the wirings to have the same shape. Accordingly, it can be possible to reduce capacitance deviation caused by formation of contact holes.

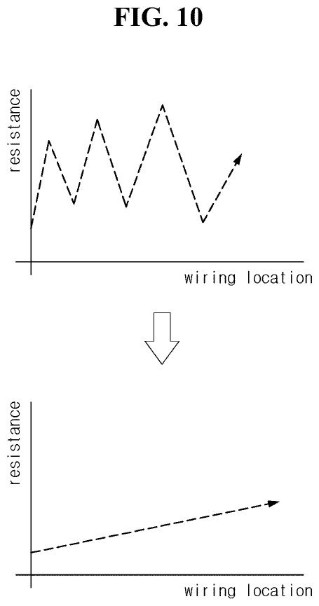

FIG. 10 is a diagram explaining the wiring structure of an embodiment, as compared to the wiring structure of a related experimental example.

FIG. 10 is based on the wiring structure of the first embodiment shown in FIG. 5. In the wiring structure of the experimental example, a touch routing line including a double wiring area and an alternating wiring area, similarly to the wiring structure of the first embodiment, but no interlayer structure change section is included in the alternating wiring area.

As shown in FIG. 10, the related experimental example exhibits abrupt fluctuations in resistance based on wiring locations, whereas the first embodiment can exhibit a slight increase in resistance when the wiring location is varied, without abrupt fluctuations as seen in the experimental example. Therefore, by forming a wiring structure based on the first embodiment or by incorporating, in the wiring structure, structures as in the second embodiment and/or the third embodiment, it can be possible to further reduce or minimize factors causing resistance deviation between wirings. In other words, the related example suffers from sharp fluctuations in resistance depending on the location along the wiring (e.g., “zig-zag” type of resistance). In contrast, the embodiment's resistance increases only slightly and proceeds smoothly in a linear pattern as its position along the wiring changing. Accordingly, resistance deviation between wires can be effectively minimized, which can improve touch sensing.

As apparent from the above description, the present disclosure has an effect of enhancing the performance of a touchscreen (minimization of noise between touch channels, touch sensing sensitivity enhancement, etc.) through a reduction in resistance deviation between wirings (resistance compensation) or minimization thereof. Additionally, the present disclosure can have an effect of achieving a narrow bezel when a display device including a touchscreen is embodied.

Effects according to the example embodiments of the disclosure are not limited to the above-illustrated contents, and more various effects can be included in the specification.

Although the preferred embodiments of the present disclosure have been disclosed for illustrative purposes, those skilled in the art will appreciate that various modifications, additions and substitutions are possible, without departing from the scope and technical ideas of the disclosure as disclosed in the accompanying claims.

What is claimed is:

1. A display device comprising:
a display panel configured to display an image; and
a touchscreen disposed on the display panel, the touchscreen including:
a first touch routing line layer,
an insulating layer covering the first touch routing line layer,
a second touch routing line layer disposed on the insulating layer, and
a plurality of touch routing lines including a contact hole configured to interconnect the first touch routing line layer and the second touch routing line layer,
wherein the plurality of touch routing lines include at least two interlayer structure change sections where interlayer wiring positions of the first touch routing line layer and the second routing line layer are changed.

2. The display device according to claim 1, wherein the plurality of touch routing lines include at least one of:
a first area including one first touch routing line layer disposed as a lower layer; or
a second area including one second touch routing line layer disposed as an upper layer.

3. The display device according to claim 2, wherein the first area and the second area are alternately disposed for at least one wiring among the plurality of touch routing lines.

4. The display device according to claim 3, wherein the plurality of touch routing lines include a third area including the first area and the second area.

5. The display device according to claim 1, wherein two neighboring touch routing lines among the plurality of touch routing lines have a different number of contact holes relative to each other.

6. The display device according to claim 5, wherein wiring resistances of the two neighboring touch routing lines are equal or substantially equal.

7. The display device according to claim 1, wherein two neighboring touch routing lines among the plurality of touch routing lines have a same number of contact holes.

8. The display device according to claim 7, wherein wiring lengths of the two neighboring touch routing lines are equal or substantially equal.

9. The display device according to claim 1, wherein the plurality of touch routing lines include a line extension portion extending from the contact hole in one direction that extends away from a double wiring area.

10. The display device according to claim 9, wherein the plurality of touch routing lines include at least one of a first area including one first touch routing line layer disposed as a lower layer, or a second area comprising one second touch routing line layer disposed as an upper layer, and
wherein the first area and the second area are alternately disposed for at least one wiring among the plurality of touch routing lines.

11. The display device according to claim 10, wherein the line extension portion is in a third area that includes the first area and the second area, and the line extension portion extends to the first area or the second area.

12. A touchscreen comprising:
a first touch routing line layer;
an insulating layer covering the first touch routing line layer;
a second touch routing line layer disposed on the insulating layer; and
a plurality of touch routing lines including a contact hole configured to interconnect the first touch routing line layer and the second touch routing line layer,
wherein the plurality of touch routing lines include at least two interlayer structure change sections where interlayer wiring positions of the first touch routing line layer and the second routing line layer are changed.

13. The touchscreen according to claim 12, wherein two neighboring touch routing lines among the plurality of touch routing lines have a different number of contact holes relative to each other.

14. The touchscreen according to claim 13, wherein wiring resistances of the two neighboring touch routing lines are equal or substantially equal.

15. The touchscreen according to claim 12, wherein two neighboring touch routing lines among the plurality of touch routing lines have a same number of contact holes.

16. The touchscreen according to claim 15, wherein wiring lengths of the two neighboring touch routing lines are equal or substantially equal.

17. A display device comprising:
a plurality of subpixels configured to display an image;
a plurality touch electrodes configured to detect a touch;
a first touch routing line disposed in a bezel area outside of the plurality of subpixels, the first touch routing line including a first-first touch routing line layer and a first-second touch routing line layer;
a second touch routing line disposed adjacent to the first touch routing line in the bezel area, the second touch routing line including a second-first touch routing line layer and a second-second touch routing line layer; and
an insulation layer extending between the first-first touch routing line layer and the first-second touch routing line layer, and extending between the second-first touch routing line layer and the second-second touch routing line layer,
wherein the bezel area includes:
a double wiring area including the first-first touch routing line layer overlapping with the first-second touch routing line layer and the second-first touch routing line layer overlapping with the second-second touch routing line layer, and
an alternating wiring area including a first-first segment of the first touch routing line having a portion of the first-second touch routing line layer that does not overlap with the first-first touch routing line layer, and a first-second segment of the first touch routing line that includes a portion of the first-first touch routing line layer that does not overlap with the first-second touch routing line layer, and
wherein the first-first segment transitions into the first-second segment.

18. The display device according to claim 17, wherein the alternating wiring area further includes:
a second-first segment of the second touch routing line having a portion of the second-first touch routing line layer that does not overlap with the second-second touch routing line layer, and
a second-second segment of the second touch routing line that includes a portion of the second-second touch routing line layer that does not overlap with the second-first touch routing line layer, and
wherein the second-first segment transitions into the second-second segment of the second touch routing line.

19. The display device according to claim 18, wherein the first-first segment of the first touch routing line having the portion of the first-second touch routing line layer is adjacent to the second-first segment of the second touch routing line having the portion of the second-first touch routing line layer, and
wherein the insulation layer is between the portion of the first-second touch routing line layer and the portion of the second-first touch routing line layer.

20. The display device according to claim 17, wherein the first touch routing line includes a first plurality of contact holes extending through the insulation layer where the first-first touch routing line layer electrically connects with first-second touch routing line layer, and
wherein the second touch routing line includes a second plurality of contact holes extending through the insulation layer where the second-first touch routing line layer electrically connects with second-second touch routing line layer.
